(19) United States
(12) Patent Application Publication
(10) Pub. No.: US 2013/0198074 A1
(43) Pub. Date: Aug. 1, 2013

(54) SYSTEM AND METHOD FOR PRE-PURCHASING GASOLINE

(71) Applicants: Jeffrey Allen Cox, O'Fallon, MO (US); Mostafa Hussein Sabet, Greenwich, CT (US)

(72) Inventors: Jeffrey Allen Cox, O'Fallon, MO (US); Mostafa Hussein Sabet, Greenwich, CT (US)

(73) Assignee: MASTERCARD INTERNATIONAL, INC., Purchase, NY (US)

(21) Appl. No.: 13/363,742

(22) Filed: Feb. 1, 2012

(51) Int. Cl. G06Q 20/28; G06Q 20/40

(52) U.S. Cl. 705/44

(57) ABSTRACT

A method is provided for permitting a consumer to purchase gasoline without contemporaneously taking delivery of the gasoline. The method includes establishing a credit of a purchase of gasoline at a specified price per unit, without delivery. The method further includes authenticating a purchase of a certain number of units of gasoline at a certain price per unit, with delivery, from a gas retailer. The purchase is compared with the credit to determine if the credit may be redeemed with the sale. If so, the sale amount is adjusted to reflect an adjusted sale amount, and the adjusted sale amount is then cleared as a final transaction. Advantageously, with the subject invention, a consumer may pre-purchase gasoline at an agreed-to price without delivery of the gasoline, with receiving credit at a subsequent purchase in a single transaction, even if the amount of gasoline exceeds the pre-purchase amount.

### FIELD OF THE INVENTION

This invention relates to systems and methods for pre-purchasing gasoline without taking delivery thereof at the time of purchase.

### BACKGROUND OF THE INVENTION

Various techniques are known in the prior art for purchasing gasoline in bulk at agreed-to prices without taking delivery thereof. Typically, the gasoline is bought as an investment, such as with options. With such arrangements, various rights are sold to purchase, and take delivery of, gasoline at a later date at agreed-to pricing. These arrangements are typically tied into structured investments and generally not useable at a retail level.

Techniques have been also developed to permit pre-purchasing of gasoline at a retail level. For example, U.S. Published Patent Application No. 2009/0307098 A1 to Verona discloses a fixed price fuel method which includes setting up an account for pre-purchasing gasoline with subsequent fill-ups at the gas station being credited to the extent of any pre-purchase value on the account. If the account is depleted, however, a consumer can not further purchase within the system. This presents a problem where a consumer would like to partially pay for a gasoline purchase with a credit based on a pre-purchase and partially pay for the gasoline directly out of pocket.

U.S. Published Patent Application No. 2007/0267482 A1 to Ruckart et al. discloses a gasoline pre-payment method which utilizes an account in which pre-paid units are maintained and monitored. Upon purchase of gasoline, a verification system evaluates if sufficient pre-paid units are available. Where balance is due beyond the pre-paid units, a point of sale device prompts a consumer to provide an additional form of payment such as a credit or debit account or cash, with additional payment being separately made for the excessive balance.

### SUMMARY OF THE INVENTION

A method is provided herein for permitting a consumer to purchase gasoline from a retail location without contemporaneously taking delivery of the gasoline. The method includes recording details in a database of a purchase of a specified number of units of gasoline at a specified price per unit, without delivery of the gasoline, to establish, in an account, a first credit. The first credit is associated with one or more gas retail locations. The account is associated with a financial transaction instrument. The method further includes authenticating a transaction of a sale amount, based on the financial transaction instrument, over a computer network to purchase a certain number of units of gasoline at a certain price per unit, with delivery, from a transacted gas retail location. The transaction is processed including comparing the transaction with the first credit using a computing device. If it is determined that the transacted gas retail location does not correspond with any of the one or more gas retail locations associated with the first credit, the sale amount is cleared with no adjustment of the first credit. If it is determined that the transacted gas retail location corresponds with one of the one or more gas retail locations associated with the first credit, the first credit may be fully or partially redeemed as follows. If it is determined that the specified number of units is equal to or greater than the certain number of units, a credit is established equal to the sale amount, and the first credit is adjusted to reflect an adjusted first credit corresponding to a number of units equal to the difference between the specified number of units and the certain number of units, and corresponding to the specified price per unit. If it is determined that the certain number of units is greater than the specified number of units, a charge is calculated by taking the difference between the certain number of units and the specified number of units and multiplying the difference by the certain price per unit, with the first credit being adjusted to zero. The sale amount is adjusted to reflect an adjusted sale amount by making the adjusted sale amount equal to the sale amount reduced by the credit, or making the adjusted sale amount equal to the charge. The adjusted sale amount is then cleared as a final transaction. Advantageously, with the subject invention, a consumer may pre-purchase gasoline at an agreed-to price without delivery of the gasoline, with receiving credit at a subsequent purchase in a single transaction, even if the amount of gasoline exceeds the pre-purchase amount.

These and other features of the invention will be better understood through a study of the following detailed description and accompanying drawings.

### BRIEF DESCRIPTION OF THE DRAWINGS

FIG. 1 is a schematic of a system formed in accordance with the subject invention;

FIG. 2 is a flowchart setting forth a method in accordance with the subject invention;

FIGS. 3 and 4 schematically show private data subelements useable with financial transactions in accordance with the subject invention; and,

FIGS. 5 and 6 are tables showing codes useable with the private data subelements.

### DETAILED DESCRIPTION OF THE INVENTION

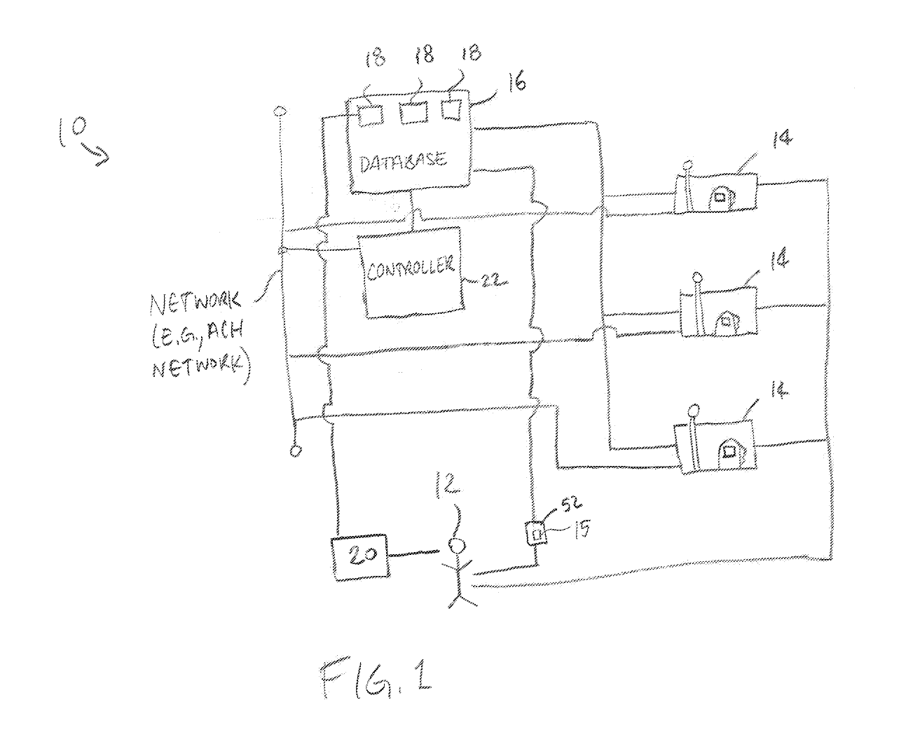

With reference to FIG. 1, a system 10 is shown which allows for the pre-purchasing of gasoline by a consumer 12 for one or more gasoline retail locations 14.

The system 10 includes one or more databases 16 configured to store details regarding gasoline purchases. Any form of computer-based database may be utilized. The consumer establishes an account 18 in one or more of the databases 16 in which details of purchases are maintained. The purchases are associated not only with the consumer 12, but also with one or more specified retail location(s) 14. The account 18 is associated with one or more financial transaction instruments 20 associated with the consumer 12. As used herein, a “financial transaction instrument” is any instrument which may be used to make a purchase, including a credit card, a debit card, and wireless/web-enabled devices (such as a fob, cellphone, Smartphone, etc.) configured to conduct a financial transaction, with such devices being associated with a credit account, debit account, checking account, savings account and/or any other form of bank or financial account.

The system 10 also includes a controller 22 which resides on one or more computer processing units (CPU's). The controller 22 is linked to the databases 16 to manipulate information contained within the accounts 18. The controller 22 is operatively linked to a computer network for processing financial transactions (e.g., credit and/or debit transactions), such as the Automated Clearing House (ACH) network. As described below, such networks are configured to authenticate and clear debit or credit transactions electronically. The controller 22 may reside on the network or be linked thereto.

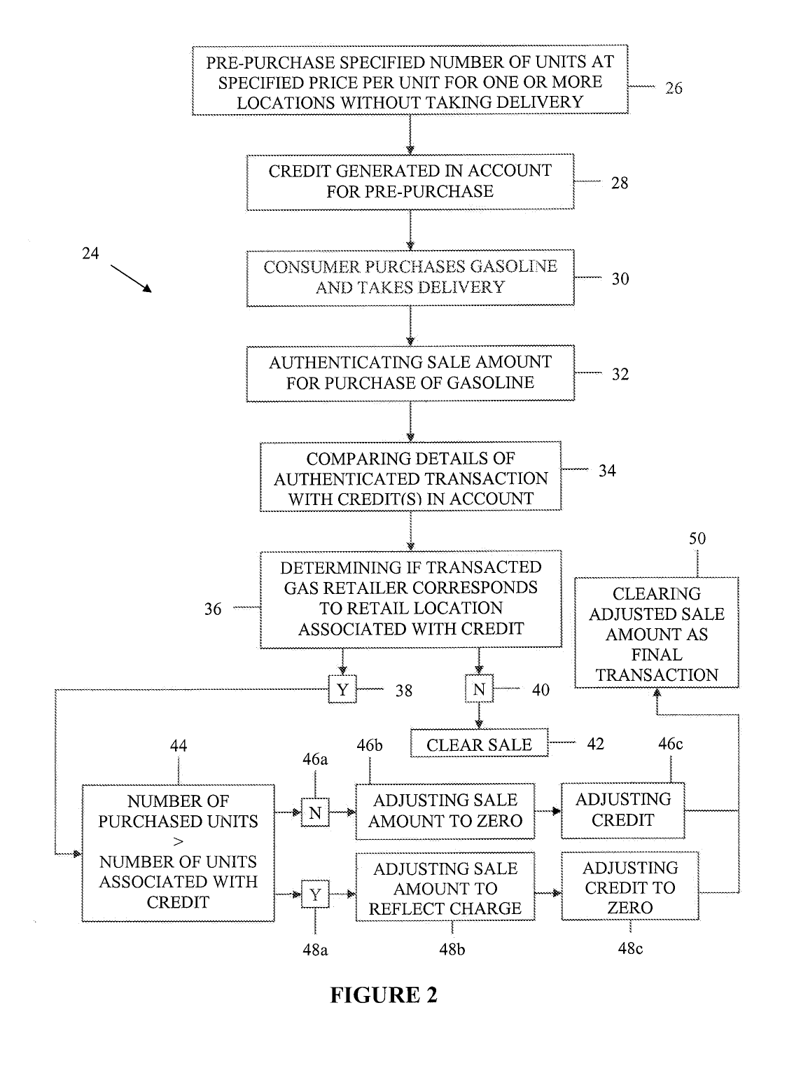

With reference to FIG. 2, a method 24 in accordance with the subject invention is shown. In a first step 26, the consumer 12 purchases a specified number of units of gasoline at a specified price per unit for one or more particular retail locations 14, without contemporaneously taking delivery of the gasoline. In the United States, the units will typically be gallons, but other units may be utilized, such as liters, pounds, kilograms, imperial gallons, and so forth. As a result, as indicated in step 28, a credit is generated in the account 18 for the pre-purchased amount. The credit corresponds to the specified number of units of gasoline, the specified price per unit, and one or more particular retail locations 14.

As will be appreciated by those skilled in the art, various forms of payment may be used to establish the credit in the account 18. Preferably, the financial transaction instrument 20 is used to make a credit or debit transaction to establish the credit in the account. Advantageously, with use of the financial transaction instrument 20, and with the financial transaction instrument 20 being associated with the account 18, the pre-purchase may be easily associated with the account 18. Alternative forms of payment may be used, such as cash, check, direct deposit, wire transfer and so forth, to establish the credit in the account 18. The payment may be made through a web-enabled device, such as with a Smartphone software application, through Internet access to an account, and so forth. Alternatively, payment may be accepted at the retail location 14 or other physical location.

The terms of the pre-purchase must be agreed to for the specified retail location 14. For example, the retail location 14 may offer for sale to individual consumers, a fixed number of units of gasoline at a fixed price (e.g., that day's rate). It is envisioned that it would be possible to allow the consumer 12 to make unsolicited bids to buy certain amounts of gasoline at certain prices. The pre-purchase would be only consummated with approval from, or on behalf of, the particular retail location 14.

It is also noted that many gasoline retail locations are individually owned, even though part of a franchise. Thus, it is anticipated that the majority of pre-purchases will be directly agreed to by the proprietor of the particular retail location 14. It is possible that a franchise may offer simultaneously pre-purchases of gasoline at multiple locations in a region or nationally. This may allow for the credit in the account 18 to be valid at more than one of the retail locations 14. With pre-purchase, valid retail locations 14 where the credit may be redeemed will be specified and noted in the account 18 for that credit.

The particular retail locations 14 offering pre-purchase of gasoline may be identified to consumers in different ways. For example, a webpage or website may be established to provide details of available gasoline for pre-purchase. In addition, or alternatively, a Smartphone, or equivalent, software application 15 may be prepared which alerts a user as to retail locations 14 making available gasoline for pre-purchase. The software application 15 may be used with a global positioning system (GPS) or equivalent to alert a user to all retail locations 14 within a certain geographic proximity to the user (i.e., within a certain geographic proximity to the device bearing the software application) which make available gasoline for pre-purchase. The software application 15 may be configured to present only the retail locations 14 having availability of gasoline for pre-purchase at the moment of presentation. Optionally, the retail locations 14 not presently having availability may be also presented for reference. The software application 15 is preferably configured to update periodically to reflect more current status. In addition, the software application 15 may be configured to transact a pre-purchase of gasoline as set forth in the first step 26. The financial transaction instrument 20 may be used to make the pre-purchase through the software application 15.

Various terms may be applied to the pre-purchase by the particular retail location 14, such as a specified term of validity. As such, the credit may expire if not used within a specified term.

With reference to a third step 30, the consumer 12 takes delivery of the gasoline from one of the specified retail locations 14. To enable redemption of the credit in the account 18, the consumer 12 uses the financial transaction instrument 20 associated with the account 18 to make a credit or debit transaction to purchase and take delivery of the gasoline. The transaction is processed as any normal transaction. In addition, the consumer 12 may take any amount of gasoline, independent of the pre-purchased amount, including an amount of units exceeding the pre-purchased amount of units.

With reference to the fourth step 32, the sale of the gasoline, at the sale price, is processed as a transaction in a sale amount. As with other credit or debit transactions, the transaction is authenticated over the processing network (e.g., ACH network) whereby approval is given for the transaction, but the transaction is not cleared for completion. Authenticated transactions are typically marked as being pending transactions (e.g., pending ACH transactions).

With reference to the fifth step 34, after authentication, and while pending, the controller 22 compares details of the transaction with the account 18 to determine if redemption applies and how the sale amount should be adjusted. Preferably, the details of the transaction include not only the sale amount, but also details relating to the purchase including the specified retail location 14, and one or both of the purchased number of units and/or the purchase price per unit. Typical electronic credit and debit transactions include the sale amount and vendor information. The vendor information may be used to determine if the transacted retailer corresponds to one of the specified retail locations 14 associated with the credit (step 36). As indicated above, the credit may be associated with more than one retail location 14. Specifically, the controller 22 determines if the transacted gas retailer from where gas was taken delivery (third step 30) corresponds to one of the retail locations 14 associated with the credit. If it is determined that the gas retailer corresponds to one of the retail locations 14 associated with the credit, redemption of the credit as follows may be allowed (step 38). If it is determined that the gas retailer does not correspond to one of the retail locations 14 associated with the credit, the controller 22 will not process redemption of the credit (step 40). The transaction from the fourth step 32 will then be allowed to clear as a sale without adjustment to the sale or to the credit in the account 18 (step 42).

Typical electronic debit or credit transactions do not include the additional details of the purchased number of units and the purchase price per unit. Although not typically transmitted, these additional details can be transmitted with a transaction in various manners. Preferably, the additional details are transmitted with the transaction, such as, for example, in spaces for additional characters included in typical electronic financial transactions. In this manner, the method 24 can be practiced without the provision of any special hardware or equipment at the retail locations 14. Some software modification may be required at the retail locations 14, particularly at the gasoline pumps, to allow for the additional details (purchased number of units, purchase price per unit) to be included and transmitted with the transaction.

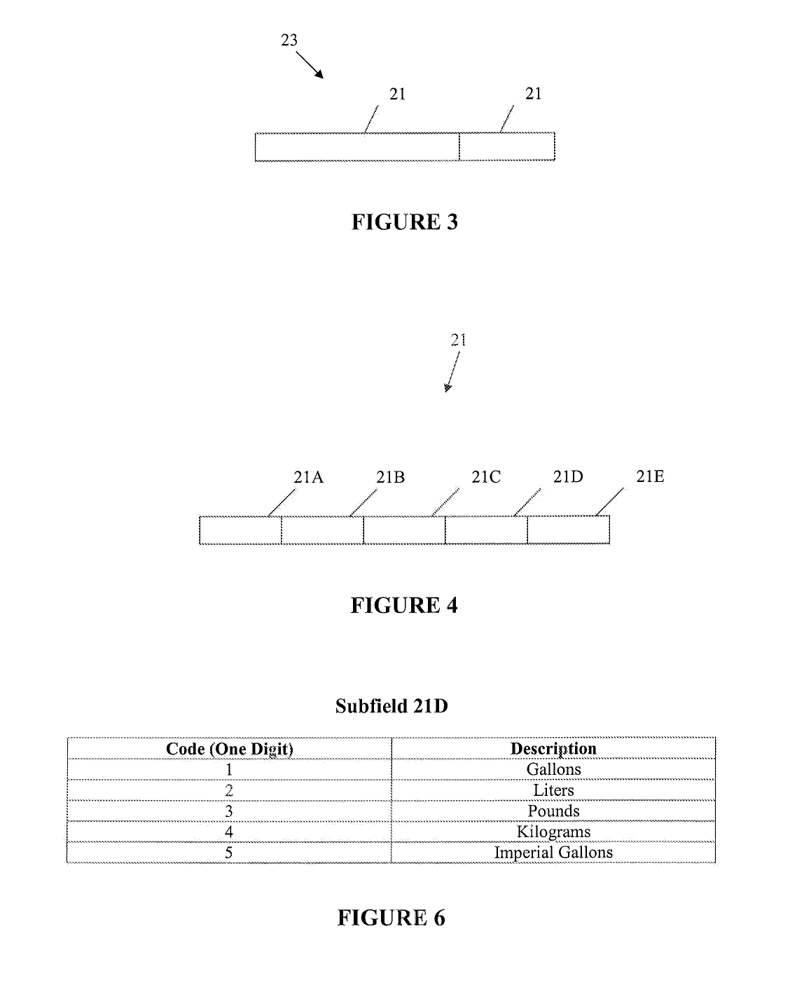

By way of non-limiting example, message elements of the electronic financial transaction may be prepared to include the additional details of the transaction. For example, MasterCard Worldwide provides its own private data subelements (PDS's) which provide additional character spaces (e.g., alphanumeric, punctuation spaces) to accommodate additional details of a transaction beyond the standard details which are transmitted (e.g., as defined by the ISO 8583 specifications). With reference to FIG. 3, one or more subelements 21 may be included with financial transaction 23. The subelement 21 may be configured to include the purchased number of units and/or purchase price per unit.

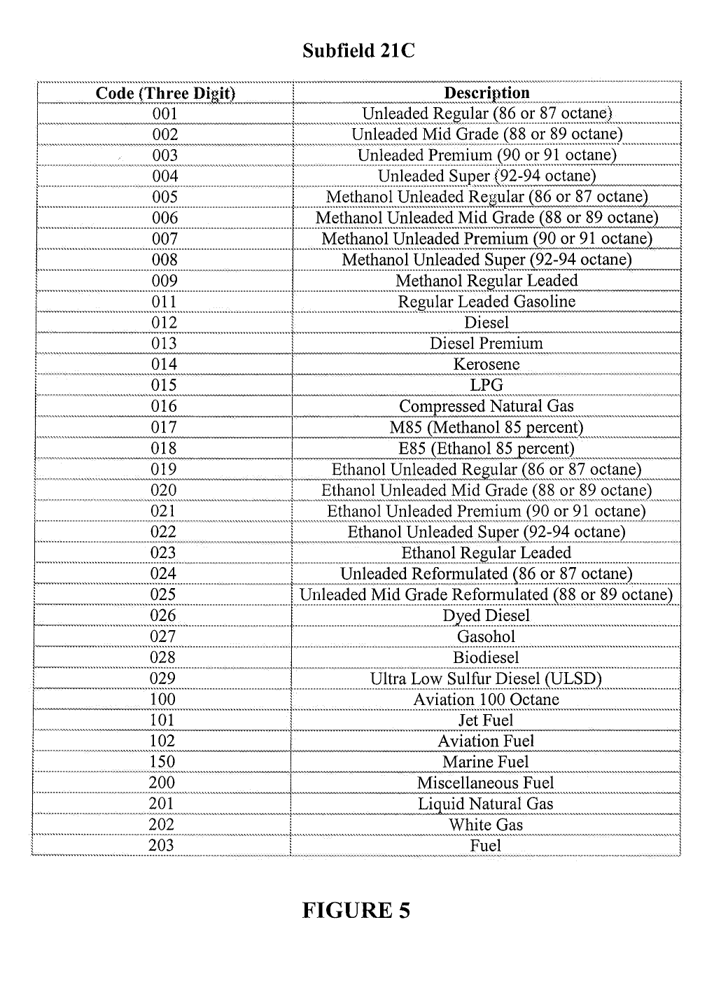

With reference to FIG. 4, the subelement 21 may be, in turn, provided with its own subfields to allow for two or more bits of information to be identified for each transaction. For example, the subelement 21 may include subfield 21A which includes purchased number of units and subfield 21B which includes purchase price per unit. These subfields may be defined to have a particular format for consistency. Additional subfields may be optionally provided. For example, subfield 21C may be included to carry a code identifying type and/or grade of gasoline purchased (e.g., unleaded regular, unleaded premium, methanol, diesel, etc.). FIG. 5 includes a table of possible codes with corresponding descriptions for subfield 21C. Subfield 21D may be included to carry a code to specify unit of measure (e.g., gallons, liters, pounds, kilograms, imperial gallons, and so forth). FIG. 6 includes a table of possible codes with corresponding descriptions for subfield 21D. Pricing can be determined without specifying the unit of measure (number of units×price per unit=cost). However, specifying the unit of measure may provide additional helpful information, for example, for later reporting. As will be appreciated by those skilled in the art, the codes and descriptions for the subfields may be in various formats.

A subfield 21E may be also included configured to carry a code indicating that a transaction relates to a purchase of gasoline. Various transactions, including transactions with the financial transaction instrument 20, are transmitted over the processing network. The controller 22 is exposed to these transactions. To determine if a transaction is eligible for consideration for redemption of a credit, the controller 22 can intercept all transactions with subsequent comparison of the related vendor and financial transaction instrument 20 to determine if credit eligibility exists. This may lead to review of numerous, unrelated transactions. To more define possible related transactions, it is preferred that a code be included in the subfield 21E indicating that a transaction relates to a gas purchase. The controller 22 can then identify the transactions carrying the code with subsequent comparison as described herein.

Where it has been determined that redemption of the credit in step 38 is proper, the controller 22, with the details of the transaction, compares any credits in the account 18 against the transaction to allow for redemption of all or part of available credits. Only credits available for the particular retail location 14 may be utilized. Once the existence of such credits is determined, the number of purchased units is compared to the number of units corresponding to the available credit (step 44). If the number of units corresponding to the credit is greater than the number of purchased units (step 46a) then an adjusted sale amount is generated which equals zero (step 46b). Also, the credit is adjusted to reduce the number of units by the redeemed amount (step 46c). For example, if the credit originally was for 12 units and a purchase of 10 units was made, the credit is adjusted to reflect an available credit of 2 units. The price per unit does not change with respect to the credit amount.

If it is determined that the purchased number of units exceeds the number of units available with the credit (step 48a), a difference is determined between the purchased number of units and the available number of units. The difference is then multiplied by the purchase price per unit to generate a charge amount. The sale amount of the transaction is then manipulated to be an adjusted sale amount equal to the charge (step 48b). This represents the amount of payment for the gasoline exceeding the pre-purchased amount. In addition, the credit which was on the account 18 is adjusted to be zero, as that credit had been fully redeemed in this transaction (step 48c).

The adjusted sale amount is then cleared in the next clearing cycle, as shown in the sixth step 50 so as to present a final transaction. The final transaction may be a zero charge, where the pre-purchased amount was sufficient to completely cover the purchase, or a charge amount where gasoline was acquired in an amount exceeding available credit. In either regard, the ultimate charge applied against the financial transaction instrument 20 is equal to any difference for excessive gasoline. The method 24 allows for a purchase to be treated within one transaction and avoids the need for charging and then reimbursing the consumer 12, even where an amount of gas is purchased which exceeds a pre-purchased amount.

It is noted that gallons may be used as a default unit of measure. With a default unit of measure, it is automatically taken that the units in the credits in accounts 18 and the units transmitted with the financial transaction are all the same. As indicated above, the system 10 can be configured such that the units are specified in the accounts 18 (e.g., gallons) and the units are specified in the financial transactions (e.g., by inclusion of a code to specify unit of measure). If necessary, the controller 22 may be configured to do conversions between units (e.g., between liters and gallons) to allow for redemption of credits where different units between the credits and financial transactions are involved.

As will be appreciated by those skilled in the art, the system 10 and the method 24 may be applied to various fuel purchases, including fuel related to, but not limited to, automobiles, boats, and airplanes. FIG. 5 lists some possible applications in the “Description” column. In addition, the system 10 and the method 24 may be adjusted with variations. For example, more than one credit (i.e., more than one pre-purchase) may be redeemed in a single purchase. Also, fees may be applied to the consumer for various uses (e.g., fee for extended duration before use). Also, the price per unit may be adjusted to set limits so that a consumer will not pay a price over a certain limit. Further, the system 10 may be configured to display and/or generate reports in various formats, e.g., paper, electronically, etc. to present account activity (credits, purchases, redemptions, etc.). For example, a graphical user interface 52 (e.g., computing device, cell phone, Smartphone, etc.) may be configured to display activity in the accounts 18. The graphical user interface 52 may be linked (through network connection, wireless, Internet, etc.) to the database 16, the controller 22 and/or any portion of a network allowing access to such details. In addition, or alternatively, the system 10 may generate periodic written reports which are delivered to an account holder.

1. A method for permitting a consumer to purchase gasoline from a retail location without contemporaneously taking delivery of the gasoline, said method comprising:
recording details in a database of a purchase of a specified number of units of gasoline at a specified price per unit, without delivery of said gasoline, to establish, in an account, a first credit, said first credit being associated with one or more gas retail locations, said account having associated therewith a financial transaction instrument;
authenticating a transaction of a sale amount, based on said financial transaction instrument, over a computer network to purchase a certain number of units of gasoline at a certain price per unit, with delivery, from a transacted gas retail location;
processing said transaction, including comparing said transaction with said first credit, using a computing device,
wherein, if it is determined that said transacted gas retail location does not correspond with any of said one or more gas retail locations associated with said first credit, then,
said sale amount is cleared with no adjustment of said first credit, and
wherein, if it is determined that said transacted gas retail location corresponds with one of said one or more gas retail locations associated with said first credit, then,
if it is determined that said specified number of units is equal to or greater than said certain number of units, a credit is established equal to said sale amount, and said first credit is adjusted to reflect an adjusted first credit corresponding to a number of units equal to the difference between said specified number of units and said certain number of units, and corresponding to said specified price per unit, and,
if it is determined that said certain number of units is greater than said specified number of units, a charge is calculated by taking the difference between said certain number of units and said specified number of units and multiplying said difference by said certain price per unit, said first credit being adjusted to zero;
selectively adjusting said sale amount to reflect an adjusted sale amount by,
if it is determined that said specified number of units is equal to or greater than said certain number of units, making said adjusted sale amount equal to said sale amount reduced by said credit, and
if it is determined that said certain number of units is greater than said specified number of units, making said adjusted sale amount equal to said charge, and clearing said adjusted sale amount as a final transaction applied against said financial transaction instrument.

2. A method as in claim 1, wherein said first credit is established by a credit or debit transaction with said financial transaction instrument.

3. A method as in claim 1, wherein said first credit is established by payment through one or more of the forms of payment chosen from the group consisting of cash, check, direct deposit and wire transfer.

4. A method as in claim 1, further comprising providing a software application configured to identify gas retail locations within a certain geographic proximity which offer sale of gasoline without delivery thereof.

5. A method as in claim 4, wherein said software application is configured to transact said purchase of said specified number of units of gasoline at said specified price per unit, without delivery of said gasoline.

6. A method as in claim 5, wherein said financial transaction instrument is used in said purchase of said specified number of units of gasoline at said specified price per unit, without delivery of said gasoline, to establish said first credit.

7. A method as in claim 1, wherein said transaction includes a code indicating that said transaction relates to a purchase of gasoline.
